(19) United States
(12) Patent Application Publication
(10) Pub. No.: US 2022/0250587 A1
(43) Pub. Date: Aug. 11, 2022

(54) WIPER DEVICE

(71) Applicant: CAP CORPORATION, Gyeongsangbuk-do (KR)

(72) Inventors: Tae Hun KIM, Daegu (KR); Yun Soo KIM, Gyeongsangbuk-do (KR)

(21) Appl. No.: 17/587,772

(22) Filed: Jan. 28, 2022

(30) Foreign Application Priority Data
Feb. 9, 2021 (KR) 10-2021-0018496

(51) Int. Cl. B60S 1/34

(52) U.S. Cl. CPC B60S 1/3425

(57) ABSTRACT

Wiper device includes: an adhering member for wiping off the foreign matters; a support member for elastically supporting the adhering member; and a cover member with an inner space accommodating the support member. The cover member includes: an upper surface with inclination from a lower corner to a top corner with respect to a horizontal plane, based on a cross section perpendicular to a longitudinal direction; and a vertical lateral surface formed vertically with respect to the horizontal plane and meeting the upper surface to form the top corner. The upper surface includes: a first inclined surface forming an acute angle with the horizontal plane and starting from the lower corner; and a second inclined surface forming an obtuse angle with the first inclined surface and continuing to the first inclined surface to extend to the top corner.

### BACKGROUND

### 1. Field of the Invention

The present disclosure relates to a wiper device.

### 2. Discussion of Related Art

In general, when a windshield surface is contaminated due to dust or various foreign matters in the air or snow or rain caused by weather conditions in a running vehicle, it becomes difficult to secure a field of view, which adversely affects safe driving. Accordingly, a wiper device for a vehicle for wiping off snow, rain, or foreign matters on the windshield surface is installed in the vehicle as means of securing a field of view for driver's safe driving.

However, when a strong traveling wind is generated due to high-speed driving of a vehicle, a wiper device does not adhere to a window due to the traveling wind, thereby causing a problem in that wiping is not performed.

### SUMMARY OF THE INVENTION

An object of the present disclosure is to provide a wiper device capable of maintaining wiping performance by adhering to a window despite a strong traveling wind.

According to an aspect of the present disclosure, a wiper device configured for removing foreign matters attached to a window and connected to a wiper arm includes: an adhering member configured to wipe off the foreign matters; a support member configured to elastically support the adhering member so that the adhering member adheres to the window; and a cover member having an inner space formed therein, the inner space accommodating the support member, wherein the cover member includes: an upper surface with an inclination that rises from a lower corner to a top corner with respect to a horizontal plane, based on a cross section perpendicular to a longitudinal direction; and a vertical lateral surface formed vertically with respect to the horizontal plane and meeting the upper surface to form the top corner, and wherein the upper surface includes: a first inclined surface forming an acute angle with respect to the horizontal plane and starting from the lower corner; and a second inclined surface forming an obtuse angle with respect to the first inclined surface, continuing to the first inclined surface, and extending to the top corner.

In the upper surface, a ratio (H/W) of a vertical height H to a horizontal width W may be 0.47 to 0.59.

The acute angle of the first inclined surface with respect to the horizontal plane may be 13° to 18°.

The obtuse angle of the second inclined surface with respect to the first inclined surface may be 110° to 120°.

The vertical lateral surface may form an inclination of 85° to 90° with respect to the horizontal plane.

### BRIEF DESCRIPTION OF THE DRAWINGS

FIG. 1 is a perspective view illustrating a wiper device according to an embodiment of the present disclosure.

FIG. 2 is an exploded perspective view illustrating the wiper device according to an embodiment of the present disclosure.

FIG. 3 is a cross-sectional view illustrating a cover member in the wiper device according to an embodiment of the present disclosure.

FIG. 4 is a graph illustrating results of a floating test of a wiper device according to an embodiment of the present disclosure.

FIG. 5 is a graph illustrating results of a floating test of a wiper device according to an embodiment of the present disclosure.

FIG. 6 is a graph illustrating results of a floating test of a wiper device according to an embodiment of the present disclosure.

FIG. 7 is a graph illustrating results of a floating test of a wiper device according to an embodiment of the present disclosure.

FIG. 8 is a graph illustrating results of a floating test of a wiper device according to an embodiment of the present disclosure.

### DETAILED DESCRIPTION OF EXEMPLARY EMBODIMENTS

Hereinafter, an embodiment of the present disclosure will be described in detail with reference to the accompanying drawings.

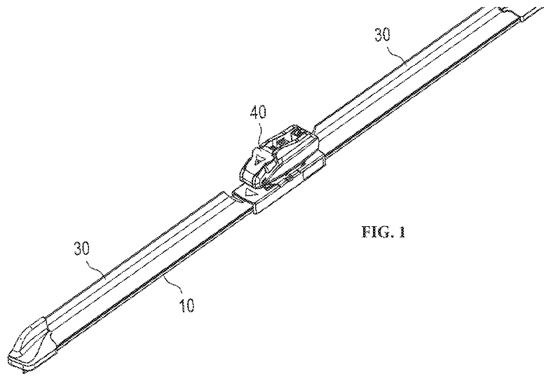

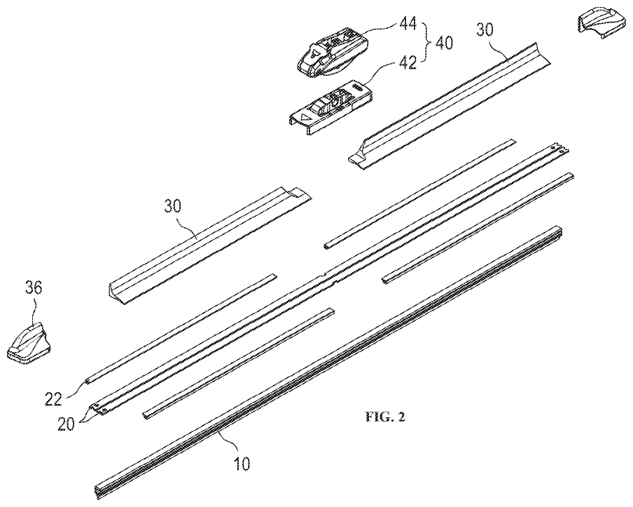

FIG. 1 is a perspective view illustrating a wiper device according to an embodiment of the present disclosure, and FIG. 2 is an exploded perspective view illustrating the wiper device according to an embodiment of the present disclosure.

Referring to FIGS. 1 and 2, a wiper device according to an embodiment of the present disclosure is configured to remove foreign matters attached to a window and is connected to a wiper arm, and includes an adhering member 10, a support member 20, and a cover member 30.

The adhering member 10 is a part that adheres to the window to wipe off foreign matters, and as the adhering member 10 of the present embodiment, all of the known various adhering members 10 such as a wiper blade made of rubber may be used.

The support member 20 is a part that elastically supports the adhering member 10 so that the adhering member 10 adheres to the window. A plate-shaped spring may be used as the support member 20.

Referring to FIG. 2, according to the present embodiment, a plate-shaped spring having a predetermined curvature and elastic force according to a window shape is used as the support member 20, so that the wiper blade, which is the adhering member 10, may adhere to a curved surface of a window of a vehicle.

In this case, mounting grooves are formed on either lateral surface of the adhering member 10 in a longitudinal direction, and the plate-shaped spring may be fitted into the mounting groove.

Meanwhile, an adapter 40 connected to a wiper arm (not illustrated) may be mounted on the support member 20. The adapter 40 may include a first member 42 that is coupled to the support member 20 and a second member 44 that is rotatably connected to the first member 42 and coupled to the wiper arm.

The cover member 30 is configured to cover the support member 20 and has a form extending in the longitudinal direction of the support member 20. The cover member 30 may have an inner space S formed therein to accommodate the support member 20.

A spoiler structure is formed on an outer side of the cover member 30 of the present embodiment, so that it is possible to provide additional adhesion to the support member 20 by using air pressure.

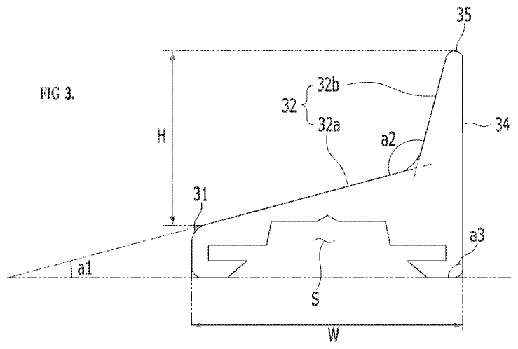

FIG. 3 is a cross-sectional view illustrating the cover member 30 in the wiper device according to an embodiment of the present disclosure.

Referring to FIG. 3, the cover member 30 of the present embodiment may form a spoiler structure including an upper surface 32 and a vertical lateral surface 34.

When viewed from a cross section perpendicular to the longitudinal direction, the cover member 30 of the present embodiment may include a flat bottom surface (horizontal plane) and a base formed at a constant thickness with respect to the flat bottom surface. In this case, the upper surface 32 with an inclined structure that rises from one side toward the other side on the base may be formed. In addition, a lateral surface on the other side of the base may extend upward to form the vertical lateral surface 34.

The inner space S open to the bottom is formed in the base, and a part of the adhering member 10 and the support member 20 are inserted and coupled thereto. An insertion groove into which the support member 20 is inserted may be formed on the lateral surface of the inner space S, and a coupling member 22 (refer to FIG. 2) may be added between the insertion groove and the support member 20.

In addition, caps 36 are coupled to both end portions of the cover member 30, and thus, the inner space S is not exposed to the outside.

Meanwhile, on one side of the spoiler, the upper surface 32 may meet the base to form a lower corner 31, and on the other side thereof, the upper surface 32 may meet the vertical lateral surface 34 to form a top corner 35. In this case, the lower corner 31 is disposed in a direction in which a traveling wind blows, and thus, may be a corner positioned in the forefront with respect to air acting on the spoiler. The top corner 35 may be a corner that is positioned in the opposite direction of the traveling wind and positioned at the top of the upper surface 32.

Accordingly, the upper surface 32 may be provided with an inclination rising from the lower corner 31 to the top corner 35 with respect to the horizontal plane (bottom surface). In addition, the vertical lateral surface 34 may be formed vertically with respect to the horizontal plane and may meet the upper surface 32 to form the top corner 35.

In particular, the upper surface 32 may include a first inclined surface 32a that forms an acute angle a1 with respect to the horizontal plane and starts from the lower corner 31, and a second inclined surface 32b that forms an obtuse angle a2 with respect to the first inclined surface 32a, and continues to the first inclined surface 32a and extends to the top corner 35. Therefore, in the spoiler, a two-step inclined surface of the first inclined surface 32a of the acute angle a1 and the second inclined surface 32b of the obtuse angle a2 may be formed in a direction in which the traveling wind is received, and a vertical plane may be formed in an opposite direction to the direction.

In this case, the acute angle a1 of the first inclined surface 32a with respect to the horizontal plane may be 13° to 18°.

In addition, the obtuse angle a2 of the second inclined surface 32b with respect to the first inclined surface 32a may be 110° to 120°.

In addition, an angle a3 of the vertical lateral surface 34 with respect to the horizontal plane may be 85° to 90°.

Meanwhile, in the upper surface 32, a ratio (H/W) of a vertical height H to a horizontal width W may be 0.47 to 0.59.

In the spoiler structure of the present embodiment having the above-described conditions, it is confirmed through simulation and experimental results that high lift performance may be obtained. That is, it is confirmed that the wiper device according to the present embodiment may maintain the performance of the wiper device adhering to the window even in a high-speed traveling wind.

Specifically, the experimental results are as follows.

Table 1 shows the results of a floating test of the wiper device according to the change in the acute angle a1 of the first inclined surface 32a. Here, a floating speed is a maximum traveling wind speed at which the wiper device may be operated adhering to the window. In this case, the horizontal width W and the vertical height H of the upper surface 32 are maintained constant, and the vertical lateral surface 34 is also maintained at a constant angle.

TABLE 1

| Acute angle (a1) | Floating speed (km/h) |
|---|---|
| 10° | 80 |
| 11° | 95 |
| 12° | 115 |
| 13° | 145 |
| 14° | 150 |
| 15° | 165 |
| 16° | 180 |
| 17° | 170 |
| 18° | 165 |
| 19° | 130 |
| 20° | 100 |

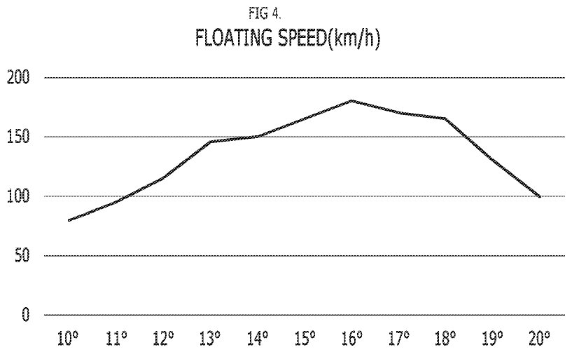

Table 1 shows the floating speed of the wiper device according to the change in the acute angle a1 of the first inclined surface 32a, and FIG. 4 is a graph illustrating the results of the floating test of the wiper device according to the change in the acute angle a1 of the first inclined surface 32a.

As shown in Table 1 and FIG. 4, initially, as the acute angle a1 of the first inclined surface 32a increases, the floating speed tends to increase. That is, initially, the increase in the acute angle a1 and the lift performance tend to be proportional. However, when the acute angle a1 exceeds a certain value, the floating speed tends to decrease as the acute angle a1 increases. That is, when the acute angle a1 exceeds a certain value, the increase in the acute angle a1 and the lift performance tend to be inversely proportional. In summary, it may be confirmed that the acute angle a1 of the first inclined surface 32a tends to increase until it reaches a certain value and then decrease. In particular, through this experiment, when the acute angle a1 of the first inclined surface 32a is set to 13° to 18°, it may be confirmed that the wiper device has an effect of preventing the floating even for the high-speed traveling wind of 140 Km/h or more.

Table 2 shows the results of the floating test of the wiper device according to the change in the obtuse angle a2 of the second inclined surface 32b. Here, the floating speed is the maximum traveling wind speed at which the wiper device may be operated adhering to the window. In this case, the horizontal width W and the vertical height H of the upper surface 32 are maintained constant, and the acute angle a1 of the first inclined surface 32a is also maintained at a constant angle.

TABLE 2

| Obtuse angle (a2) | Floating speed (km/h) |
|---|---|
| 80° | 75 |
| 85° | 90 |
| 90° | 110 |
| 95° | 120 |
| 100° | 155 |
| 105° | 160 |
| 110° | 170 |
| 115° | 180 |
| 120° | 170 |
| 125° | 120 |
| 130° | 95 |

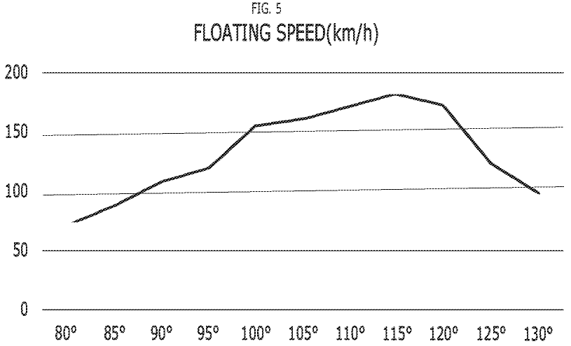

Table 2 shows the floating speed of the wiper device according to the change in the obtuse angle a2 of the second inclined surface 32b, and FIG. 5 is a graph illustrating the results of floating test of the wiper device according to the change in the obtuse angle a2 of the second inclined surface 32b.

As shown in Table 2 and FIG. 5, initially, as the obtuse angle a2 of the second inclined surface 32b increases, the floating speed tends to increase. That is, initially, the increase in the obtuse angle a2 and the lift performance tend to be proportional. However, when the obtuse angle a2 exceeds a certain value, the floating speed tends to decrease as the obtuse angle a2 increases. That is, when the obtuse angle a2 exceeds a certain value, the increase in the obtuse angle a2 and the lift performance tend to be inversely proportional. In summary, it may be confirmed that the obtuse angle a2 of the second inclined surface 32b tends to increase until it reaches a certain value and then decrease. In particular, through this experiment, when the obtuse angle a2 of the second inclined surface 32b is set to 110° to 120°, it may be confirmed that the wiper device has an effect of preventing the floating even for the high-speed traveling wind of 140 Km/h or more.

Table 3 shows the results of the floating test of the wiper device according to the change of the angle a3 with respect to the horizontal plane of the vertical lateral surface 34. Here, the floating speed is the maximum traveling wind speed at which the wiper device may be operated adhering to the window. In this case, the horizontal width W and the vertical height H of the upper surface 32 are maintained constant, and the acute angle a1 of the first inclined surface 32a is also maintained at a constant angle.

TABLE 3

| Vertical lateral surface (34) | |
|---|---|
| Angle (a3) | Floating speed (km/h) |
| 80° | 75 |
| 81° | 95 |
| 82° | 110 |
| 83° | 115 |
| 84° | 120 |
| 85° | 140 |
| 86° | 150 |
| 87° | 160 |
| 88° | 175 |
| 89° | 175 |
| 90° | 180 |

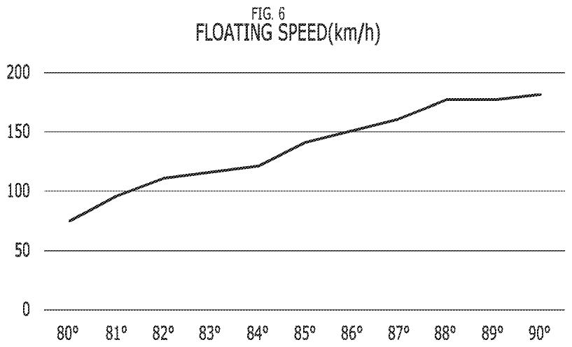

Table 3 shows the floating speed of the wiper device according to the change in the angle a3 of the vertical lateral surface 34, and FIG. 6 is a graph illustrating the results of the floating test of the wiper device according to the change in the angle a3 of the vertical lateral surface 34.

As shown in Table 3 and FIG. 6, as the angle a3 of the vertical lateral surface 34 increases, the floating speed also tends to increase until the angle a3 becomes a right angle. That is, as the angle a3 of the vertical lateral surface 34 is closer to the right angle, the lift performance tends to be improved. In particular, through this experiment, when the acute angle a3 of the vertical lateral surface 34 is set to 85° to 90°, it may be confirmed that the wiper device has an effect of preventing the floating even for the high-speed traveling wind of 140 Km/h or more.

Table 4 shows the results of the floating test of the wiper device according to the change in the horizontal width W on the upper surface 32. Here, the floating speed is the maximum traveling wind speed at which the wiper device may be operated adhering to the window. In this case, the vertical height H of the upper surface 32 is maintained constant, and the vertical lateral surface 34 is also maintained at a constant angle.

TABLE 4

| Horizontal width | |
|---|---|
| (W) | Floating speed (km/h) |
| 15.4 mm | 75 |
| 15.6 mm | 95 |
| 15.8 mm | 110 |
| 16.0 mm | 145 |
| 16.2 mm | 160 |
| 16.4 mm | 170 |
| 16.6 mm | 180 |
| 16.8 mm | 165 |
| 17.0 mm | 155 |
| 17.2 mm | 125 |
| 17.4 mm | 90 |

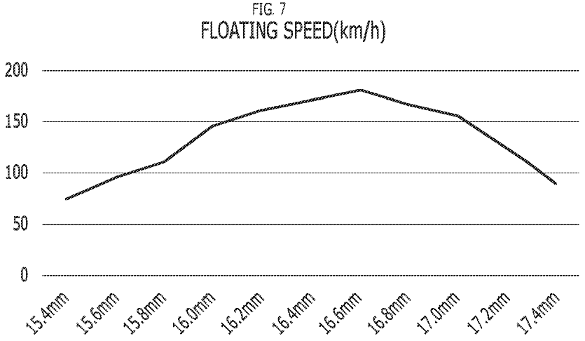

Table 4 shows the floating speed of the wiper device according to the change in the horizontal width W of the upper surface 32, and FIG. 7 is a graph illustrating the results of the floating test of the wiper device according to the change in the horizontal width W of the upper surface 32.

As shown in Table 4 and FIG. 7, initially, as the horizontal width W of the upper surface 32 increases, the floating speed tends to increase. That is, initially, the increase in the horizontal width W and the lift performance tend to be proportional. However, when the horizontal width W exceeds a certain value, the floating speed tends to decrease as the horizontal width W increases. That is, when the horizontal width W exceeds a certain value, the increase in the horizontal width W and the lift performance tend to be inversely proportional. In summary, it may be confirmed that the horizontal width W of the upper surface 32 tends to increase until it reaches a certain value and then decrease. In particular, through this experiment, when the horizontal width W of the upper surface 32 is set to 16 to 17 mm, it may be confirmed that the wiper device has an effect of preventing the floating even for the high-speed traveling wind of 140 Km/h or more.

Table 5 shows the results of the floating test of the wiper device according to the change in the vertical height H on the upper surface 32. Here, the floating speed is the maximum traveling wind speed at which the wiper device may be operated adhering to the window. In this case, the horizontal width W of the upper surface 32 is maintained constant, and the vertical side surface 34 is also maintained at a constant angle.

TABLE 5

| Vertical height (H) | Floating speed (km/h) |
|---|---|
| 10.9 mm | 80 |
| 11.1 mm | 90 |
| 11.3 mm | 120 |
| 11.5 mm | 160 |
| 11.7 mm | 170 |
| 11.9 mm | 180 |
| 12.1 mm | 175 |
| 12.3 mm | 170 |
| 12.5 mm | 160 |
| 12.7 mm | 130 |
| 12.9 mm | 95 |

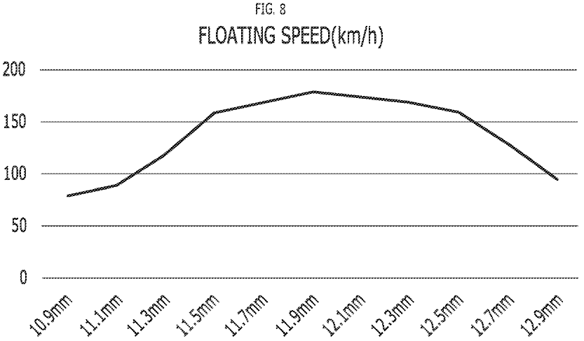

Table 5 shows the floating speed of the wiper device according to the change in the vertical height H of the upper surface 32, and FIG. 8 is a graph illustrating the results of the floating test of the wiper device according to the change in the vertical height H of the upper surface 32.

As shown in Table 5 and FIG. 8, initially, as the vertical height H of the upper surface 32 increases, the floating speed tends to increase. That is, initially, the increase in the vertical height H and the lift performance tend to be proportional. However, when the vertical height H exceeds a certain value, as the vertical height H increases, the floating speed tends to decrease. That is, when the vertical height H exceeds a certain value, the increase in the vertical height H and the lift performance tend to be inversely proportional. In summary, it may be confirmed that the vertical height H of the upper surface 32 tends to increase until it reaches a certain value and then decrease. In particular, through this experiment, when the vertical height H of the upper surface 32 is set to 8 to 9.5 mm, it may be confirmed that the wiper device has an effect of preventing the floating even for the high-speed traveling wind of 140 Km/h or more.

Therefore, in order to prevent the floating of the wiper device for the high-speed traveling wind of 140 Km/h or more, the horizontal width W of the upper surface 32 may be 16 to 17 mm, and the height H thereof may be 8 to 9.5 mm. In summary, the ratio (H/W) of the vertical height H to the horizontal width W on the upper surface 32 for preventing the floatation of the wiper device for the high-speed traveling wind may be about 0.47 to 0.59.

Meanwhile, the present embodiment has exemplified that the first inclined surface 32a is formed as a flat surface, but is not limited thereto, and the first inclined surface may be formed as a curved surface. In particular, it is preferable that the first inclined surface receiving the traveling wind has a curved structure having a cross section protruding upward to enhance the anti-floating function.

A wiper device according to the present disclosure has a spoiler structure in which a two-step inclined surface of a first inclined surface of an acute angle and a second inclined surface of an obtuse angle is formed in a direction in which a traveling wind is received, and a vertical plane is formed in an opposite direction to the direction, and thus, may be operated by adhering to a window even in a high-speed traveling wind.

Although a certain embodiment of the present disclosure has been described hereinabove, it may be understood by those skilled in the art that the present disclosure may be variously modified and altered without departing from the scope and spirit of the present disclosure described in the following claims.

Many embodiments other than that described above fall within the scope of the claims of the present disclosure.

What is claimed is:

1. A wiper device configured for removing foreign matters attached to a window and connected to a wiper arm, the wiper device comprising:
an adhering member configured to wipe off the foreign matters;
a support member configured to elastically support the adhering member such that the adhering member adheres to the window; and
a cover member having an inner space formed therein, the inner space configured for accommodating the support member,
wherein the cover member comprises:
an upper surface with an inclination that rises from a lower corner to a top corner with respect to a horizontal plane, based on a cross section perpendicular to a longitudinal direction; and a vertical lateral surface formed vertically with respect to the horizontal plane and meeting the upper surface to form the top corner, and
wherein the upper surface comprises:
a first inclined surface forming an acute angle with respect to the horizontal plane and starting from the lower corner; and a second inclined surface forming an obtuse angle with respect to the first inclined surface and continuing to the first inclined surface to extend to the top corner.

2. The wiper device of claim 1, wherein in the upper surface, a ratio (H/W) of a vertical height H to a horizontal width W is 0.47 to 0.59.

3. The wiper device of claim 1, wherein the acute angle of the first inclined surface with respect to the horizontal plane is 13° to 18°.

4. The wiper device of claim 1, wherein the obtuse angle of the second inclined surface with respect to the first inclined surface is 110° to 120°.

5. The wiper device of claim 1, wherein the vertical side surface forms an inclination of 85° to 90° with respect to the horizontal plane.
